(19) United States
(12) Patent Application Publication
(10) Pub. No.: US 2010/0268858 A1
(43) Pub. Date: Oct. 21, 2010

(54) SATA data connection device with raised reliability

(76) Inventor: Chung-Liang Lee, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/585,992

(22) Filed: Sep. 30, 2009

(30) Foreign Application Priority Data
Apr. 20, 2009 (TW) 098112985

(51) Int. Cl. G06F 13/12

(52) U.S. Cl. 710/74

(57) ABSTRACT

There is disclosed a data connection device, particularly to a SATA data connection device with raised plug-in stability and reliability. The SATA data connection device mainly comprises a SATA data connection seat and a SATA component terminal. A seat body of the SATA data connection seat is provided therein with a slot. On each of two short perimeters of the seat body, there is additionally provided a laterally extending support frame having a snap-fit groove. Moreover, a shell layer of the SATA component terminal is additionally provided at the lower edge of each of two short perimeters thereof with a snap fitting. A snap hook, which may be pressed to tilt, is provided at the bottom end of the snap fitting. When a SATA data connector of the SATA component terminal is insertedly connected into the slot of the SATA data connection seat, the snap hook of the snap fitting may be also snapped into the snap-fit groove. Thus, not only the plug-in stability and reliability of the data connection device may be enhanced significantly, but also the accuracy of high-speed data transmission may be assured.

### FIELD OF THE INVENTION

The present invention is related to a data connection device, particularly to a SATA data connection device with raised plug-in stability and reliability.

### BACKGROUND

SATA is an acronym of Serial ATA (Serial Advanced Technology), which is also called as serial ATA. SATA is a computer bus, mainly used for data transmission between the motherboard and large storage (for instance, hard disk and optical disc drive). As for data transmission, SATA is faster, and supports hot swapping such that it is allowed to plug in and unplug hardware when the computer is on. The most significant difference between SATA and previous design is that a smaller flat cable may be used, facilitating air ventilation inside the case.

Currently, the SATA specification includes SATA 1.5 Gbit/s and SATA 3.0 Gbit/s having been released, as well as SATA 6.0 Gbit/s coming soon. In view of numerous advantages mentioned above, SATA interface has been generally used in various commercially available storages, such as hard disks (HDDs) and optical disc drives (DVDs), for example. SATA interface is the most essential computer storage interface now and in the future.

Referring to FIG. 1, there is shown a schematic diagram illustrating a conventional SATA data connection device 10 according to the standard developed by Serial ATA International Organization (SATA-IO). As shown in this figure, on a printed circuit board 19, there are provided with a plurality of electronic elements comprising at least one SATA data connection seat 11, in which a slot 13 having a plurality of connection pins is provided. A SATA component terminal 15, such as a SATA data transmission line, for example, may be insertedly connected into the slot 13, whereby the object of SATA data transmission is obtained.

On the side of the conventional SATA component terminal 15, there is further provided with a mistake-proofing means 17, not only facilitating accurate alignment of the SATA component terminal 15 when it is insertedly connected by a user, but also desirably increasing the stability of the SATA component terminal 15 in the SATA connection seat 11 thereby.

Referring to FIG. 2, there is shown a perspective diagram of a second conventional SATA data connection device. A conventional SATA data connection device 20 comprises a SATA data connection seat 21 allowed to be fixedly provided on a motherboard or printed circuit board, and a SATA component terminal 25. The SATA data connection seat 21 comprises a seat body 22 generally in the form of a rectangular structure, having two long perimeters 221 and two short perimeters 222 formed around the outer surface thereof. Inside the seat body 22, there is provided with a slot 225 having a plurality of board-end connection pins 227. On one of the long perimeters 221 of the seat body 22, there is provided with at least one snap groove for compression-fit means 215.

The SATA component terminal 25 is provided with a shell layer 253, generally in the form of a rectangular structure. The outer surface of the shell layer 253 may be formed with two long perimeters 2531 and two short perimeters 2532. Furthermore, at the bottom side of the SATA component terminal 25, there is projectingly provided with a SATA data connector 251 having a plurality of second connection pins (not shown) thereon. On one of the long perimeters 2531 of the SATA data connector 251, there is provided with a compression-fit means 26, while on one of the short perimeters 2532 of the SATA data connector 251, there may be provided with a mistake-proofing means 27. On the compression-fit means 26, there is provided with at least one compression-fit bump 265.

The SATA component terminal 25 may be a SATA data transmission line or an electronic application module with SATA interface. It is allowed to provide a working module 255 inside the shell layer 253 if the SATA component terminal 25 is used as an electronic application module with SATA interface.

When the SATA component terminal 25 is intended to be connected to the SATA data connection seat 21, the SATA data connector 251 and the mistake-proofing means 27 are insertedly connected into the slot 225, while the compression-fit means 26 is pressed and then released by an external force, leading to that the compression-fit bump 265 is snapped into the snap groove for compression-fit means 215. Thereby, the plug-in stability of the SATA data connection device 20 may be increased. Then, the board-end connection pins 227 and the second connection pins may be contacted with each other.

As described above, SATA is an extremely high-speed transmission interface. 3.0 Gbit/s is the transfer speed defined in SATA II which is most popular presently, and the transmission requirement for the extremely high transfer speed of 6.0 Gbit/s will be further defined in SATA III in the future. In this case, however, whenever an unstable connection occurs instantaneously, data loss or misjudgment during transmission may be caused possibly, resulting in a risk in secure transmission of information seriously. In view of connection stability, there are three drawbacks in the conventional SATA data connection device 10/20 as follows:
1. A 7-pin data connection device with a smaller structure, which is only approximately 20% of the prior PATA 40-pin data connection device, with an inserting force between the SATA component terminal and the SATA data connection seat far less than that of the prior PATA interface.
2. A single-surface contact between the 7-pin SATA data connection seat and the SATA component terminal, providing a gripping force far less than that provided by a multiple-surface contact in the 40-pin PATA.
3. No snap-fit mechanism or a compression-fit means with one weak side provided for the connection between the SATA data connection seat and the SATA component terminal, leading to probable swing of the SATA data wiring or the electronic application module with SATA interface of the SATA component terminal.

On account of above three drawbacks, the SATA component terminal 15/25 may probably swing or come off the SATA data connection seat 11/21, resulting in insecure transmission of SATA data, when the product subjects to the impact of external forces or is used in adverse vibration conditions.

Furthermore, this plug-in instability or transmission insecurity of the SATA data connection device is especially obvious in the products, such as industrial computers, vehicle mounted computers, computer systems used in fluid-borne vehicles (for instance, aircraft or ships), and so on. Therefore, how to strengthen the completely firm snap fit between the SATA data connection seat and the SATA component terminal has become an important task for the current and future computer system.

### SUMMARY OF THE INVENTION

It is a primary object of the present invention to provide a SATA data connection device with raised reliability, in which a SATA data connection seat is additionally provided on each of two short side perimeters thereof with a support frame and a snap-fit groove, while a SATA component terminal is provided on each of two short perimeters thereof with a corresponding snap fitting and snap hook. When the SATA component terminal is insertedly connected to the SATA data connection seat, the snap hook and the snap-fit groove may be snapped together. Thereby, not only the plug-in stability and reliability of the data connection device may be enhanced, but also the transmission security of SATA data may be increased.

It is a secondary object of the present invention to provide a SATA data connection device with raised reliability, in which a SATA data connection seat is provided on each of the long perimeters thereof with at least one upwardly extending extension frame and locating hole, while a SATA component terminal is provided on a long perimeter thereof with at least one through hole correspondingly. When the SATA component terminal is insertedly connected to the SATA data connection seat, a screw element is used to screwly engage with and then fix the at least one locating hole and the through hole. Thereby, not only the plug-in stability and reliability of the data connection device may be raised as well as the screw engagement between the SATA component terminal and the SATA male connection seat on the motherboard may be well assured without detachment, but also easy operation may be provided for a user.

It is another object of the present invention to provide a SATA data connection device with raised reliability, in which a SATA data connection seat lying horizontally against the motherboard is provided on each of two short side perimeters thereof with a guide frame. The guide frame is provided at the inner side thereof with a projecting guide strip, while a shell layer of the SATA component terminal is provided on each of two short perimeters thereof with a guide groove correspondingly. The plug-in stability and reliability of the data connection device may be raised via the guidance and snap fit between the projecting guide strip and the guide groove.

It is yet another object of the present invention to provide a SATA data connection device and a SATA component terminal having at least one means, capable of raising plug-in stability, suitably used for the assembly of various SATA connection seats and SATA component terminals. Thereby, not only the plug-in stability and transmission security of data of the SATA data connection device may be raised, but also more effective use of each SATA data connection seat and SATA component terminal may be achieved.

To achieve the previous mentioned objects, the present invention provides a SATA data connection device with raised reliability, mainly comprising: a SATA data connection seat, provided with a seat body having two long perimeters and two short perimeters formed around the outer surface thereof, inside said seat body, there being provided with a slot, while on at least one of said short perimeters of said seat body, there being provided with a support frame having a snap-fit groove, on one side of which a snap-fit wall is provided; and a SATA component terminal, provided with a shell layer having two long perimeters and two short perimeters formed around the outer surface thereof, at the bottom end of said SATA component terminal, there being provided with a SATA data connector, while on at least one of said short perimeters of said shell layer, there being connectedly provided with a snap fitting comprising a snap hook extending downwardly and movable, said SATA data connector capable of being insertedly connected to said slot, while said snap fitting leading said snap hook to pass through said snap-fit groove and then snap onto said snap-fit wall fixedly via the application of an external force.

Further, the present invention provides a SATA data connection device with raised reliability, mainly comprising: a SATA data connection seat, provided with a seat body having a slot therein, said seat body being projectingly provided on at least one side thereof with an upward extension frame in which a locating hole is provided; a SATA component terminal provided at the bottom end thereof with a SATA data connector, and at the lower edge thereof with at least one through hole; and a screw element allowed to pass through as well as fix said locating hole and said through hole.

The present invention provides a SATA data connection device with raised reliability, mainly comprising: a SATA data connection seat, lying horizontally against a printed circuit board, provided with a seat body having two long perimeters and two short perimeters formed around the outer surface thereof, there being provided inside said seat body with a slot, while there being provided on at least one of said short perimeters of said seat body with a guide frame, said guide frame being provided at the inner side thereof with a board-end guiding portion; and a SATA component terminal, having two long perimeters and two short perimeters formed around the outer surface thereof, being provided at the bottom end thereof with a SATA data connector, while on at least one of said short perimeters with a component-end guiding portion, said SATA data connector being allowed to insertedly connect to said slot, while said component-end guiding portion and said board-end guiding portion being allowed to embeddedly connect with each other.

The present invention provides a SATA data connection device with raised reliability, which is a SATA component terminal provided at the bottom end thereof with a SATA data connector, and at the lower edge thereof with at least one through hole through which a screw element may pass or with which a screw may screwly engage, said SATA component terminal being an electronic application module with SATA interface or a SATA data transmission line.

The present invention provides a SATA data connection device with raised reliability, which is a SATA component terminal comprising a shell layer having two long perimeters and two short perimeters formed around the outer surface thereof, said shell layer being projectingly provided at the bottom end thereof with a SATA data connector, and at the lower edge of at least one of said short perimeters thereof with a snap fitting connected at the front end thereof to the bottom end of said short perimeter of said shell layer as well as formed at the rear end thereof as a movable snap hook, said SATA component terminal being an electronic application module with SATA interface or a SATA data transmission line.

The present invention provides a SATA data connection device with raised reliability, which is a SATA component terminal provided at the bottom end thereof with a SATA data connector as well as having two long perimeters and two short perimeters formed around the outer surface thereof, said SATA component terminal being provided on at least one of said short perimeters thereof with a component-end guiding portion which is operated as a guide rail groove or a projecting guide strip, said SATA component terminal being an electronic application module with SATA interface or a SATA data transmission line.

The present invention provides a SATA data connection device with raised reliability, which is a SATA data connection seat, provided with a seat body having two long perimeters and two short perimeters formed around the outer surface thereof, said seat body being provided therein with a slot and provided with at least one support frame laterally extending on at least one of said short perimeters of said seat body, or at least one extension frame projecting upwardly from the outer surface of said seat body, or at least one guide frame located on at least one of said short perimeters of said seat body, wherein said support frame is provided with a snap-fit groove having a snap-fit wall at one side thereof, said extension frame is provided with a locating hole, and said guide frame is provided at inner side thereof with a board-end guiding portion.

### BRIEF DESCRIPTION OF DRAWINGS

FIG. 1 is a schematic diagram of a conventional SATA data connection device when it is used.

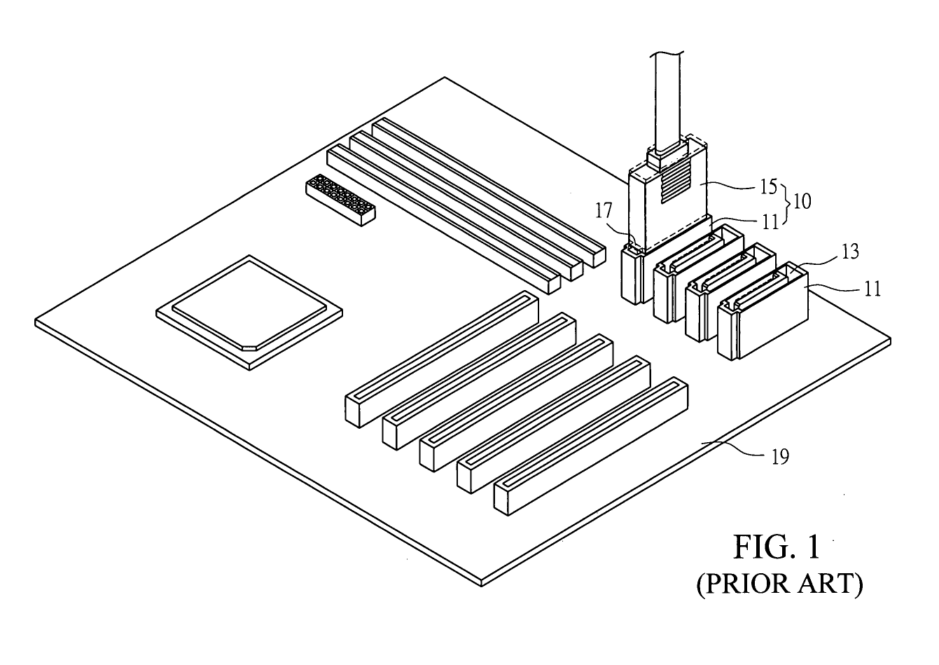

FIG. 2 is a perspective view of a second conventional SATA data connection device.

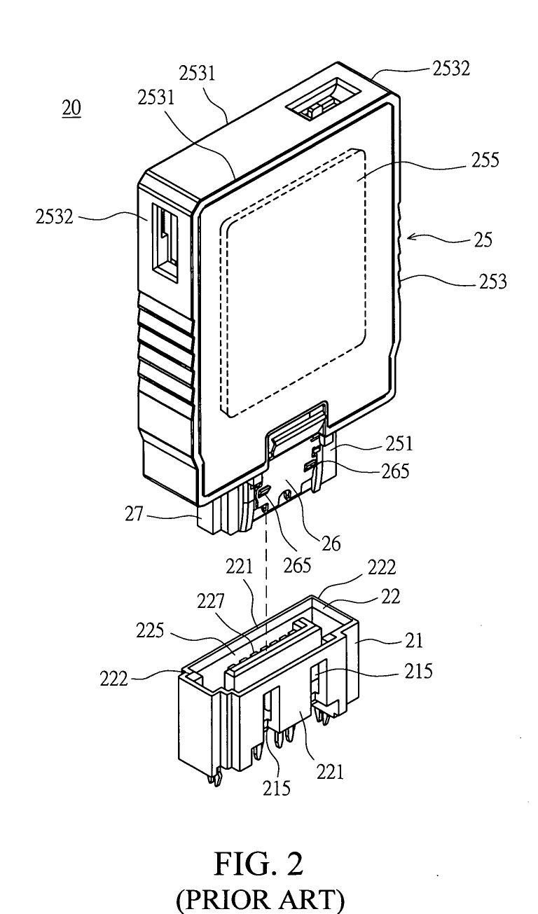

FIG. 3 is a perspective view of a data connection device according to one preferred embodiment of the present invention.

FIG. 4 is a cross section view of the data connection device of the present invention before connected.

FIG. 5 is a cross section view of the data connection device of the present invention after connected.

FIG. 6 is a schematic diagram of the data connection device of the present invention when it is used.

FIG. 7 is a perspective view of a data connection device according to another embodiment of the present invention.

FIG. 8 is a cross section view of the embodiment of the present invention shown in FIG. 7 after connected.

FIG. 9 is a perspective view of a data connection device according to another embodiment of the present invention.

FIG. 10 is a perspective view of a data connection device according to another embodiment of the present invention.

FIG. 11 is a perspective view of a data connection device according to another embodiment of the present invention.

FIG. 12 is a perspective view of a data connection device according to another embodiment of the present invention.

FIG. 13 is a perspective view of a data connection device according to another embodiment of the present invention.

FIG. 14 is a perspective view of the embodiment of the present invention shown in FIG. 13 after assembled.

FIG. 15 is a perspective view of a data connection device according to another embodiment of the present invention.

### DETAILED DESCRIPTION

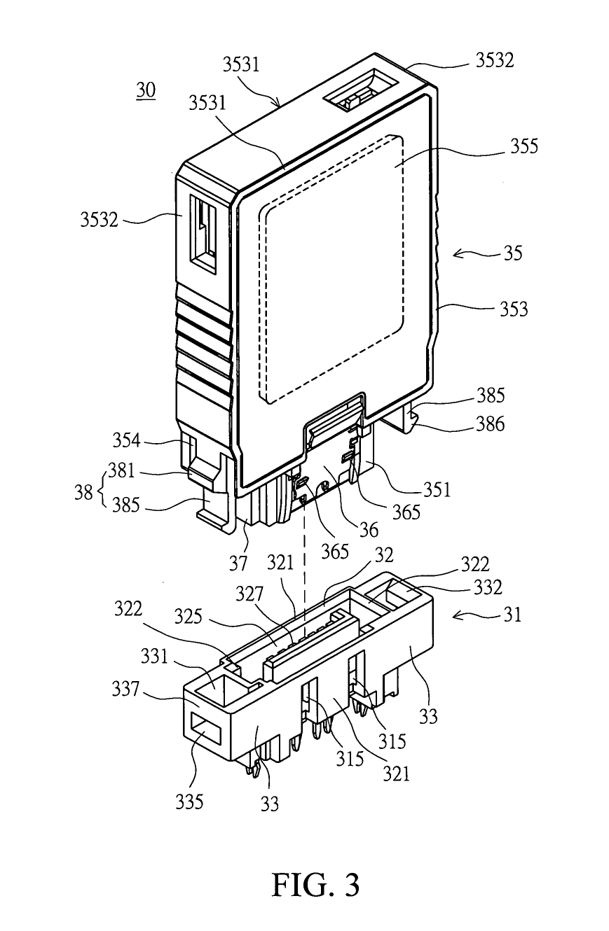

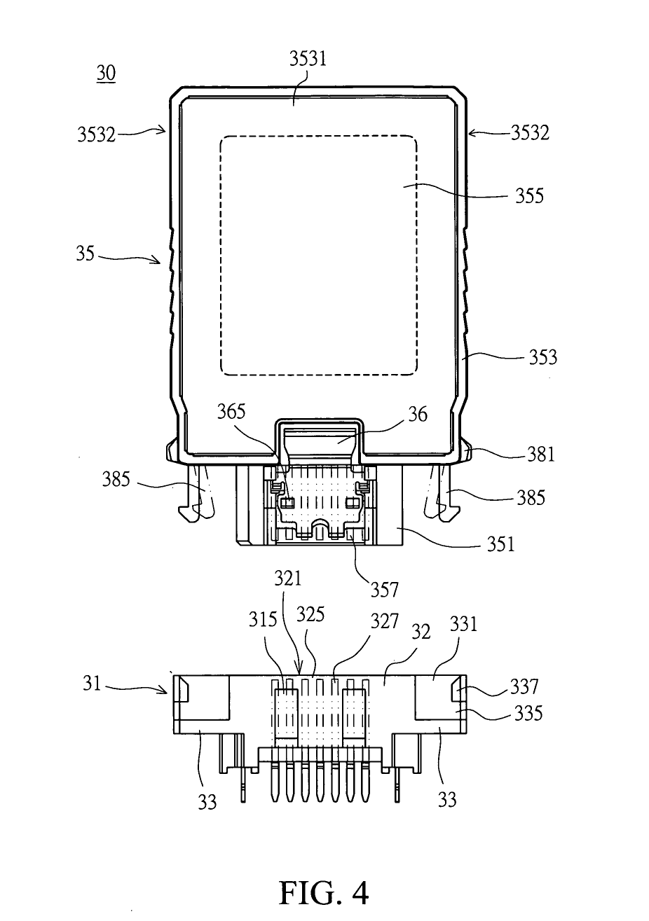

Referring to FIGS. 3 to 6, firstly, there is shown a data connection device according to one preferred embodiment of the present invention with a perspective view, a cross section view before connected, a cross section view after connected, and a schematic diagram when it is used, respectively. A data connection device 30 of the present invention is a SATA data connection device which, capable of transmitting SATA (Serial Advanced Technology Attachment) data, primarily comprises a SATA data connection device 31 and/or a SATA component terminal 35.

The SATA data connection seat 31, allowed to be fixedly provided on a motherboard or printed circuit board 39, comprises a seat body 32 in the form of a rectangular structure, having two long perimeters 321 and two short perimeters 322 formed around the outer surface thereof. Inside the seat body 32, there is provided with a slot 325 having a plurality of board-end connection pins 327, such as seven board-end connection pins, for example, presented therein. On at least one of the short perimeters 322, such as short perimeters at two sides shown in the present embodiment, of the seat body 32, there may be additionally provided with a laterally extending support frame 33, respectively, having a snap-fit groove 331. The snap-fit groove 331 is provided at the lower edge of one side thereof with a snap-fit opening 335, while the snap-fit opening 335 is further formed at the top end thereof with a snap-fit wall 337.

The SATA component terminal 35 may be an electronic application module or a SATA data transmission line with SATA interface. For the electronic application module with SATA interface shown in these figures, for instance, there is projectingly provided at the bottom end thereof with a SATA data connector 351, inside which there may be further provided with a plurality of connection pins of component terminal 357, such as seven connection pins of component terminal, for example. The SATA component terminal 35 comprises a shell layer 353, generally in the form of a rectangular structure. The outer surface of the shell layer 353 may be formed with two long perimeters 3531 and two short perimeters 3532. Furthermore, at the lower edge of at least one of the short perimeters 3532 of the shell layer 353, there is connectedly provided with a snap fitting 38, which is connected at the front end thereof to the shell layer 353, is provided in the middle thereof with a press portion 381, and is provided at the bottom end thereof with a snap hook 385.

A clearance 354 is provided between the snap fitting 38 and the shell layer 353, facilitating the motion of the snap fitting 38. The clearance 354 may be also not presented, of course, if the snap fitting 38 is projectingly provided at the bottom side of the shell layer 353 directly such that it is not surrounded at all, or if the bottom side of the shell layer 353 may be partially deformed.

When the data connection device 30 is intended to be connected so that the transmission of SATA data signal is allowed, the SATA data connector 351 of the SATA component terminal 35 may be aligned with and insertedly connected to the slot 325 of the SATA data connection seat 31, and then the connection pins of component terminal 357 of the SATA data connector 351 may be contactly connected or insertedly fitted to the board-end connection pins 327 of the slot 325.

Furthermore, the snap hook 385 of the snap fitting 38 may pass through and enter into the snap-fit groove 331 when it is tilted within the clearance 354 due to an external force being applied on the press portion 381. When the external force disappears, the snap hook 385 may be allowed to pass through the snap-fit opening 335 and then, contact with and be snapped onto the snap-fit wall 337, owing to the restoring force of the snap fitting 38 generated by the connection between the front end thereof and the shell layer 353. The stability and reliability of plug-in connection when the SATA component terminal 35 is insertedly fitted to the SATA data connection seat 31 may be raised, while the transmission security for SATA data in various environments may be also assured, due to the application force generated when the snap hook 385 snaps onto the snap-fit wall 337.

In another embodiment, on one of the long perimeters 3531 of the SATA data connector 351 of the SATA component terminal 35, there may be also provided with a compression-fit means 36 identical to that in the second conventional SATA data connection device (20), while on the short perimeter 3532 of one side, there may be provided with a mistake-proofing means 37. On the compression-fit means 36, there is provided with at least one compression-fit bump 365. On the seat body 32 of the SATA data connection seat 31, there is provided with a snap groove for compression-fit means 315. When the SATA data connector 351 is insertedly connected to the slot 325, the compression-fit bump 365 of the compression-fit means 36 may be snapped into the snap groove for compression-fit means 315 on the long perimeter 321 of the seat body 32, except that the snap hook 385 may be snapped into/onto the snap-fit opening 335/snap-fit wall 337.

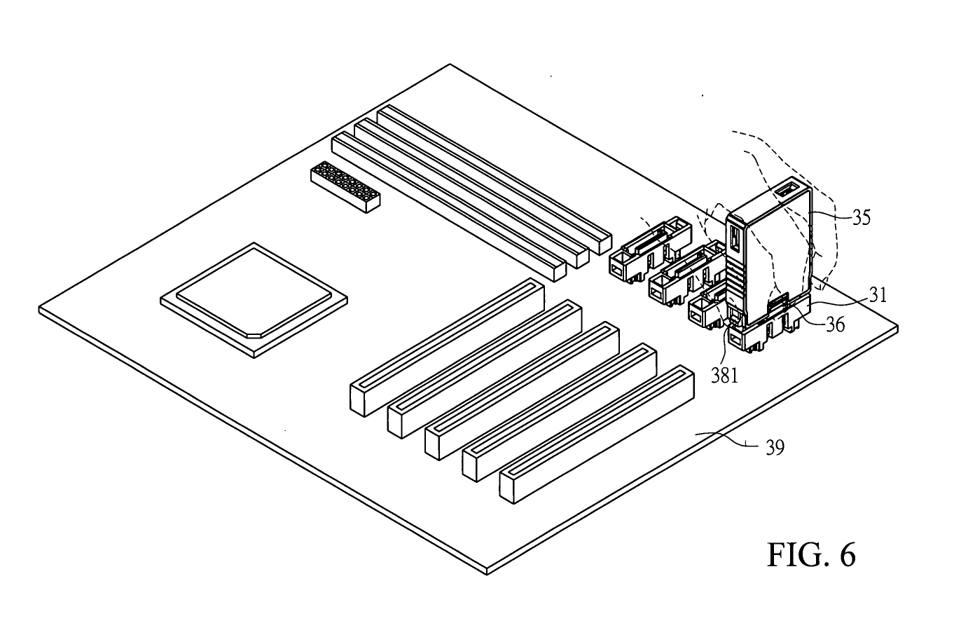

As shown in FIG. 6, in the present invention, each snap fitting 38 is provided at each of the short perimeters 3532 of two sides of the SATA component terminal 35, respectively, while the compression-fit means 36 is provided at the bottom end of one of the long perimeters 3531 of the SATA component terminal 35 and in the middle between the snap fittings 38 of two sides. In this case, whether insertedly connecting the SATA component terminal 35 to the SATA data connection seat 31, or detaching the former from the latter is intended by a user, the user may put a thumb and a middle finger onto the snap fitting 38/press portion 381 at the short perimeters 3532 of two sides, respectively, and a forefinger onto the compression-fit means 36 at the long perimeter 3531. Thus, only one single hand is required to accomplish the insertion and detachment at a time, facilitating the operation of the user.

Furthermore, there may be provided with a snap hook chamfer 386 at the bottom side of the snap hook 385, and a snap-fit groove chamfer 332 at the inner side of the snap-fit wall 337. When it is intended to insertedly connect the SATA component terminal 35 to the SATA data connection seat 31, the snap hook chamfer 386 may be guided to slide by the snap-fit groove chamfer 332, and then lead the snap hook 385 to slide into the snap-fit groove 331 and snap into/onto the snap-fit opening 335/snap-fit wall 337 smoothly.

In another embodiment of the present invention, the snap fitting 38 may be also designed without the projecting press portion 381 in the middle thereof. The snap hook 385 may be still possibly presented in the tilting mode provided that the external force is applied on the snap fitting 38 directly, and may return to vertical mode again when the external force is removed.

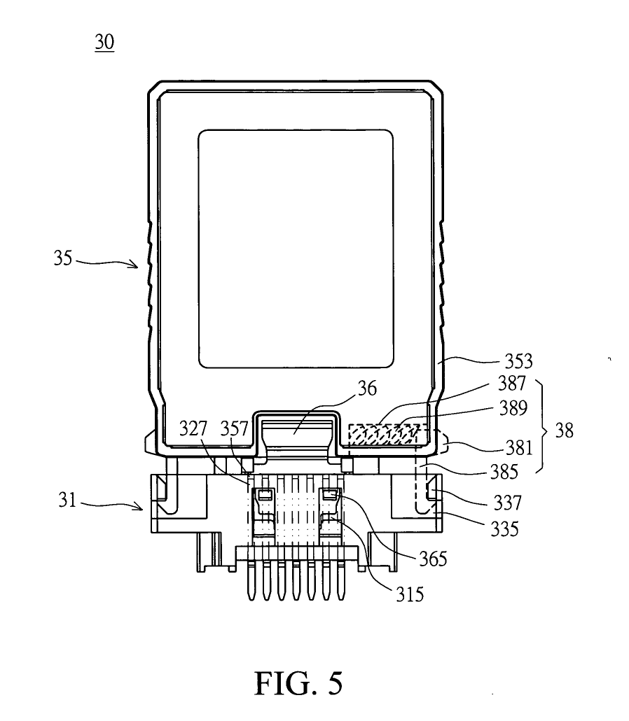

In another embodiment of the present invention, as illustrated by a dashed line in FIG. 5, the snap fitting 38 may be also designed as a press portion 381 with auto rebound, the structure of which is similar to that having been widely used in the height adjustment button for the pull handle of luggage or the locking button for the monitor of notebook and so on, mainly comprising a position limit groove 387 provided at the bottom side of the SATA component terminal 35. Inside the position limit groove 387, there is provided with an elastic element 389, which may affect the press portion 381 to move within the position limit groove 387. The snap fitting 38 is not connected to the shell layer 353. When the press portion 381 is pressed by an external force, it may lead the snap hook 385 to draw back inwardly. When the external force is removed, the press portion 381 is further pressed by the elastic element 389 so as to lead the snap hook 385 to move, and then snap into/onto the snap-fit opening 335/snap-fit wall 337

The SATA component terminal 35 may be provided therein with a working module 355 if it is an electronic application module with SATA interface selectively. The SATA component terminal may be also a memory module, an application program module, and/or a communication module, selectively.

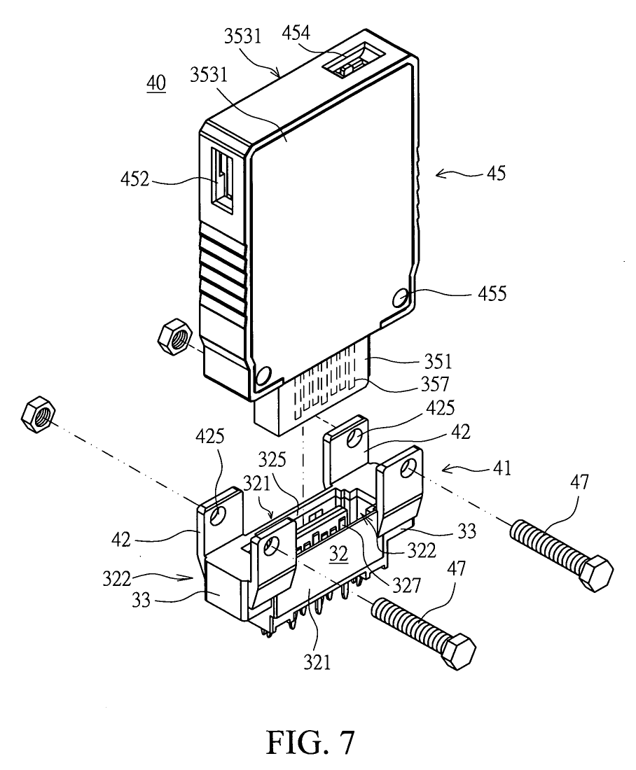

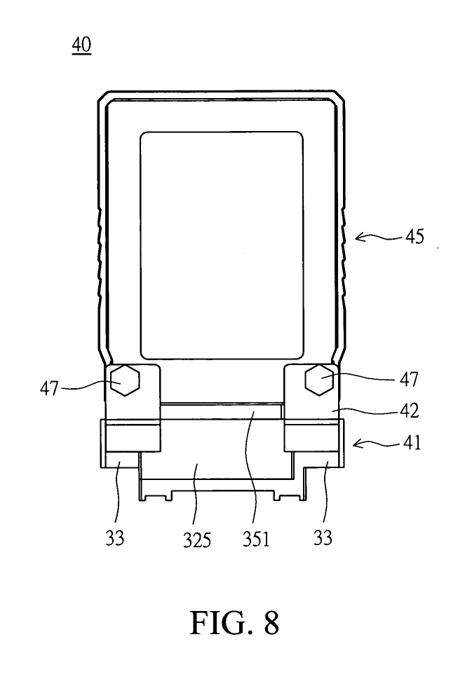

Subsequently, referring to FIGS. 7 and 8, there is shown a SATA component terminal of another embodiment of the present invention with a perspective view and a cross section view after connected, respectively. A data connection device 40 of the present invention primarily comprises a SATA data connection device 41 and a SATA component terminal 45. The SATA data connection device 41 includes a seat body 32 in the form of a rectangular structure, having two long perimeters 321 and two short perimeters 322 formed around the outer surface thereof. On at least one of the short perimeters 322 of the seat body 32, there is extendingly provided with a support frame 33 additionally, respectively. On each support frame 33, there may be provided with at least one extension frame 42, such as two symmetrical extension frames 42 shown in these figures, for example. On each extension frames 42, there may be further provided with at least one locating hole 425. Furthermore, the SATA component terminal 45 is also provided with at least one through hole 455 in a position, at the lower end of the long perimeter 3531, corresponding to the locating hole 425.

When the SATA data connector 351 of the SATA component terminal 45 is insertedly connected to the slot 325 of the SATA data connection seat 41, the connection pins of component terminal 357 may be contactly connected to the board-end connection pins 327, and the positions of the locating hole 425 and the through hole 455 may be aligned with each other. A screw element 47, such as a screw bolt, screw nut, screw rod, and etc., for example, may pass through the non-threaded locating hole 425 and through hole 455 simultaneously and screw them together. As such, not only the SATA component terminal 45 may be fixed between the extension frames 42, but also the stability and reliability of plug-in connection between the SATA component terminal 45 and the SATA data connection seat 41 may be raised.

In another embodiment, on the periphery of the SATA component terminal 45, there may be provided with a power supply port 452 to which a power transmission line is connected for supplying the SATA component terminal 45 with working power, and a data connection port 454 allowed to connect with a data transmission line so as to be connected in series to another working system or application device, respectively. The data connection port 454 may be designed with various data transmission interfaces.

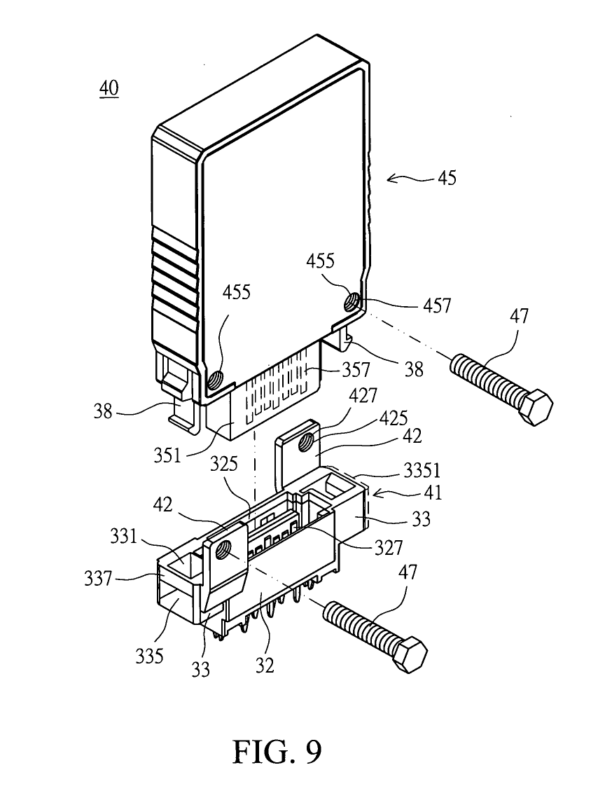

In a different embodiment, there may be selectively not provided on the periphery of the SATA component terminal 45 with the power supply port 452 or data connection port 454, in such a way the working power required by the SATA component terminal 45 may be supplied by the motherboard (39) when the individual connection pin of component terminal 357 and the board-end connection pin 327 are contactly connected with each other, as shown in FIG. 9. The technology that it is unnecessary to supply the working power of the SATA data connection device 40 with another power bus line may be seen in another approved Taiwan Patent Publication No. M321169, entitled “SATA data connector”, filed by the present applicant.

Referring to FIG. 9, there is shown a perspective view of another embodiment of the present invention. For increasing the stability of plug-in connection of the data connection device 40, a locating hole thread 427 with which the screw element 47 may be threadedly engaged is provided at the inner side of the locating hole 425. In a similar way, there may be also provided at the inner side of the through hole 455 of the SATA component terminal 45 with a through hole thread 457 with which the screw element 47 may be threadedly engaged.

In this embodiment, the right support frame 33 of the SATA data connection seat 41 is only provided at the rear end thereof with one extension frame 42/locating hole 425/locating hole thread 427, while the left support frame 33 is similarly only provided at the front end thereof with one extension frame 42/locating hole 425/locating hole thread 427. The left screw element 47 may be threadedly engaged with the through hole 455/through hole thread 457, the locating hole 425/locating hole thread 427 on the extension frame 42 in turn. Similarly, the right screw element 47 may be threadedly engaged with the locating hole 425/locating hole thread 427 on the extension frame 42, the through hole 455/through hole thread 457 in turn. In the present invention, the object of raising the plug-in stability of the data connection device 40 may be also obtained through the screw engagement provided by the screw element 47 in any one of the selectable cases including there is no nut required, only one single extension frame 42/locating hole 47 is needed, or one extension frame 42/locating hole 47 is required for each of the left and right sides individually.

Furthermore, the support frame 33 is likewise provided thereon with the snap-fit groove 331/snap-fit opening 335/snap-fit wall 337. Thereof, one SATA data connection seat 41 may be selectively cooperated with the SATA component terminal (35) having the snap fitting 38 shown in FIG. 3, the SATA component terminal 45 having the through hole 455 shown in FIG. 7, or the SATA component terminal 45 having the through hole 455 and the snap fitting 38 shown in FIG. 9.

Furthermore, except for the opening structure in the form of geometric shape, such as rectangle shown in FIG. 3, for example, the snap-fit opening 335 may be a hollowed out portion. For instance, for the snap-fit opening 335 on the left side of this figure, only the snap-fit wall 337 belongs to a physical object at the side of the snap-fit groove 331. The snap-fit opening 335 is not a real physical object. Furthermore, at the snap-fit opening 335, there is also provided as a physical thin wall 3351, as illustrated by a dashed line on the right side of this figure. Then, only one opening, allowing the snap fitting 38 to pass in and out, is provided for the whole snap-fit groove 331 at the top side thereof, so long as a projection or groove with a function similar to that of the snap-fit wall 337 is provided inside the snap-fit groove 331.

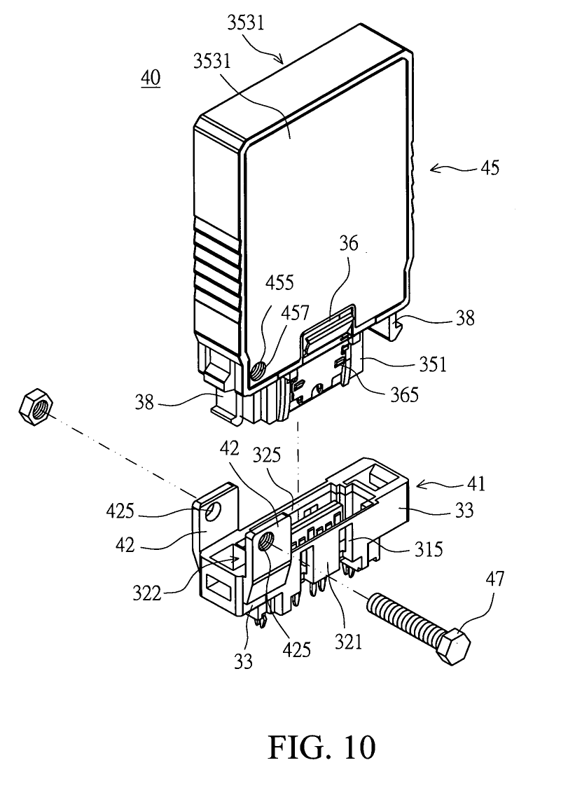

Referring to FIG. 10, there is shown a perspective view of another embodiment of the present invention. In this embodiment, on the SATA data connector 351 and the long perimeter 3531 of the SATA component terminal 45, the compression-fit means 36 and the compression-fit bump 365 are provided, while on the long perimeter 321 of the SATA data connection seat 41, the snap groove for compression-fit means 315 is provided. The compression-fit bump 365 may be snapped into the snap groove for compression-fit means 315 when the SATA data connection device 40 is connected.

Furthermore, for the SATA data connection seat 41, only the support frame 33 on the left short perimeter 322 is provided with the extension frames 42 and locating holes 425, while the support frame 33 at right side is not provided with any extension frame 42 and locating hole 425. The object of raising the stability of the data connection device 40 when it is insertedly connected may be likely obtained via only one screw element 47 threadedly engaged with locating holes 425 at left side and the through hole 455 of the SATA component terminal 41.

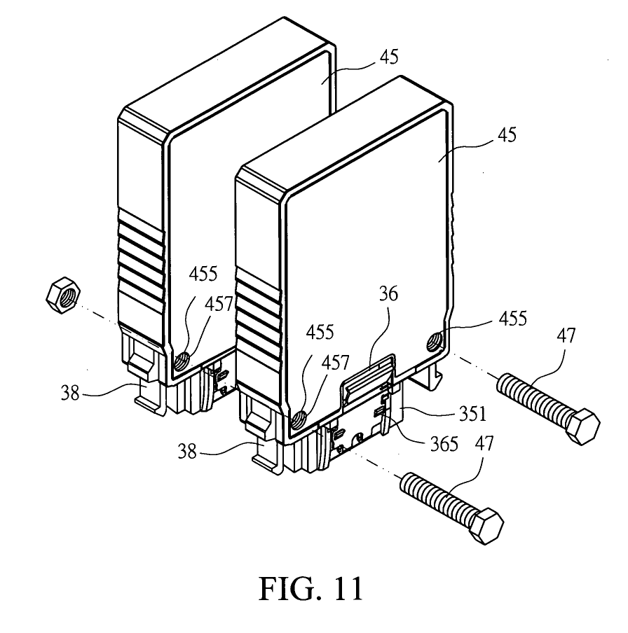

Referring to FIG. 11, there is shown a perspective view of another embodiment of the present invention. When a plurality of SATA component terminals 45 are insertedly connected to a plurality of corresponding SATA data connection seats 41 simultaneously, one single screw element 47 may be used to pass through a plurality of through holes 455 of the plurality of SATA component terminals 45. Thus, the plug-in stability of the data connection device 40 may be also raised.

In this embodiment, no matter whether the aforementioned locating holes 425 of the SATA data connection seat 41 exists, the object of raising the plug-in stability may be obtained so along as a plurality of through holes 455 are fixedly screwed together via the screw element 47. Certainly, better plug-in stability may be achieved in case that each of the through holes 455 is provided with the through hole thread 457 or cooperated with the locating holes 425.

In the above drawings, although each seat body 32 of the SATA data connection seat 31/41 is provided with a housing surrounding the whole slot 325, but the present invention is likewise suitable for use in the commercially available seat body 32 having one-sided housing body or two-sided housing body only, so long as the support frame 33 is extendingly provided horizontally on the one-sided or two-sided housing body. The variations in shape are obvious to one skilled in the art without further description herein.

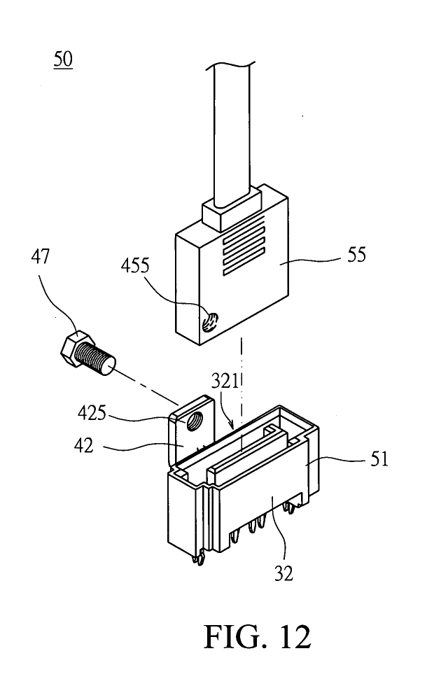

Furthermore, referring to FIG. 12, there is shown a perspective view of another embodiment of the present invention. A SATA component terminal 55 is operated as a SATA data transmission line, which is provided on the side thereof with a through hole 455. For a SATA data connection seat 51, the design of the support frame (33) is discarded, and the extension frame 42 is provided on one long perimeter 321 of the seat body 32 directly. After the SATA component terminal 55 has been insertedly connected to the SATA data connection seat 51, one screw element 47 will be used to threadedly engage with and then fix the locating hole 425 and the through hole 55. Thus, the plug-in stability of the data connection device 50 may be raised.

Although the above embodiments have been described with reference to the SATA connection device 30/40/50 having 7-pin standard SATA data connector 351 or slot 325, but the present invention may be also applied for SATA data connection devices with various standards and shapes according to the inventive principle. For instance, for a general SATA component terminal or SATA data connection seat consisting of a 7-pin SATA (data) interface connector together with a 15-pin SATA power connector, the object of the present invention may be likewise obtained, so long as the SATA data connection seat is additionally provided, at each of two sides thereof, with one horizontally extending support frame (33) which is selectedly provided thereon with the snap-fit groove (331), extension frame (42) and locating hole (425), as well as the SATA interface connector and the SATA power connector are provided with the snap fitting (38) or through hole (455), respectively. Therefore, the present invention is suitable for use in various SATA data connection devices, such as standard SATA data connection devices, eSATA data connection devices, mini-SATA data connection devices, micro-SATA data connection devices, and etc., for example.

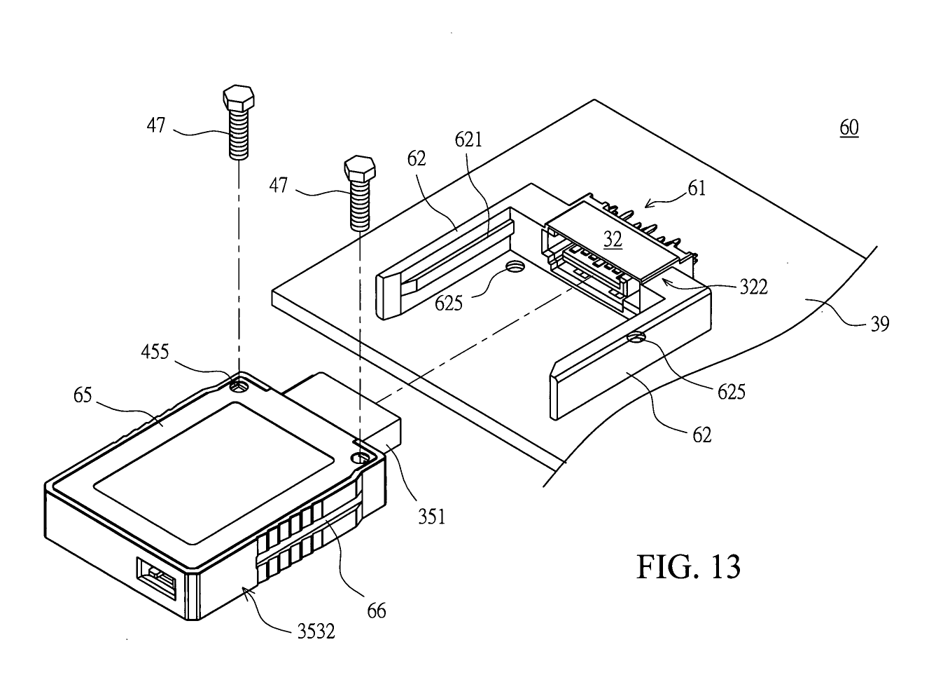

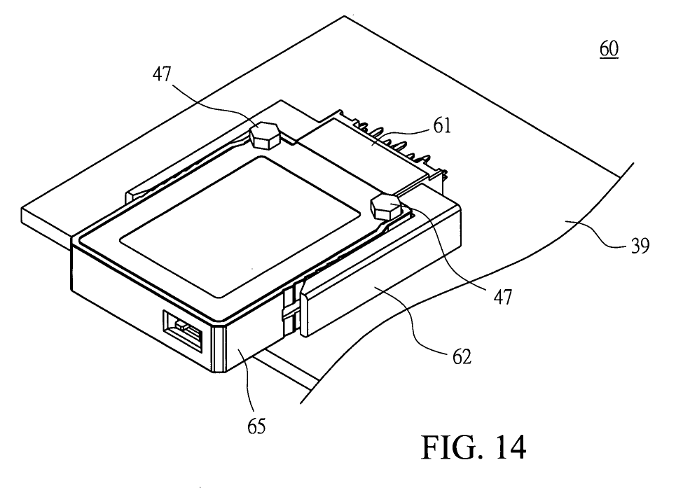

Moreover, referring to FIGS. 13 and 14, there are shown a perspective view and a perspective view of another embodiment of the present invention after connected. A data connection device 60 of the present invention primarily comprises a SATA data connection seat 61 and a SATA component terminal 65. The SATA data connection seat 61 lies horizontally against the motherboard or printed circuit board 39. On at least one of the short side perimeters 322 of the seat body 32 of the SATA data connection seat 61, there is provided with a guide frame 62. The guide frame 62 is provided at the inner side thereof with a board-end guiding portion 621, and the printed circuit board 39 is drilledly provided with at least one board-end locating hole 625. A component-end guiding portion 66 corresponding to the board-end guiding portion 621 is provided at the short side perimeter 3532 of the SATA component terminal 65, and at least one through hole 455 may be also selectively provided on this SATA component terminal 65.

When it is intended to insertedly connect the SATA component terminal 65 to the SATA data connection seat 61, the positioning effect generated by the board-end guiding portion 621 being embedded in and guiding the component-end guiding portion 66 may facilitate the SATA data connector 351 to insertedly connect to the slot 325. The screw element 47 may be also used to threadedly engage with and then fix the through hole 455 and the board-end locating hole 625. The plug-in stability of the data connection device 60 may be effectively raised in the present embodiment, due to the embedding of the board-end guiding portion 621 in the component-end guiding portion 66 and a support force provided by the horizontal contact against motherboard 39 further.

If a projecting guide strip is designed for the board-end guiding portion 621, then the component-end guiding portion 66 may be in the form of a guide rail groove, as illustrated in the figure. Certainly, the board-end guiding portion 621 may be in the form of a guide rail groove, while the component-end guiding portion 66 may be presented as a projecting guide strip.

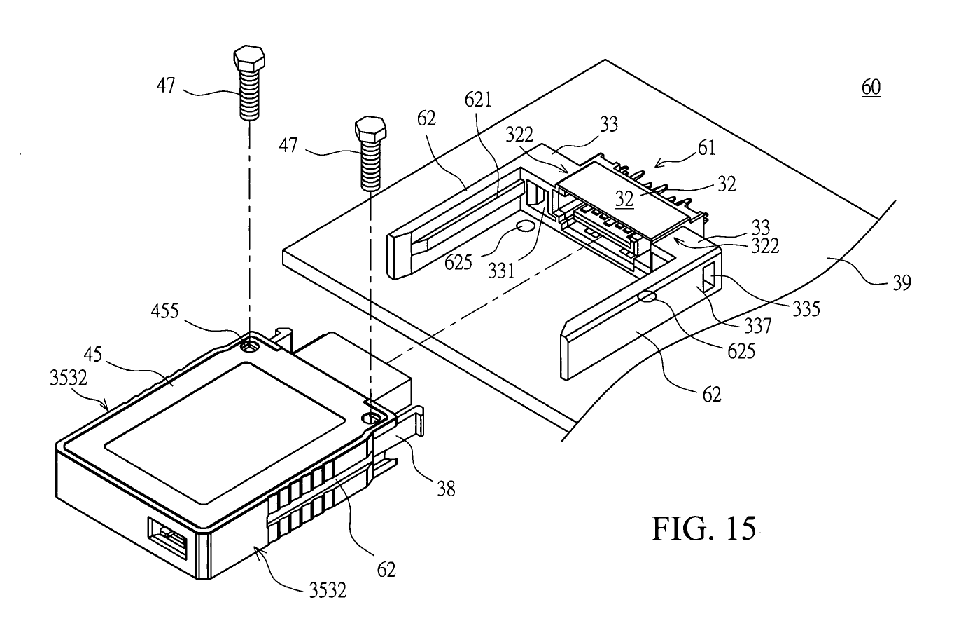

Finally, referring to FIG. 15, there is shown a perspective view of another embodiment of the present invention. The major difference between this embodiment and that illustrated in FIG. 13 is that the two short side perimeters 322 of the seat body 32 in the former is provided with the support frame 33, on which the snap-fit groove 331, snap-fit wall 337 and/or snap-fit opening 335 are provided. Furthermore, on the bottom end of the short side perimeter 3532 of the SATA component terminal 65, the snap fitting 38 is additionally provided. When the SATA component terminal 65 is insertedly connected to the SATA data connection seat 61 laterally, the snap fitting 38 may be allowed to snap into/onto the snap-fit groove 331, the snap-fit opening 335 or the snap-fit wall 337, except that the component-end guiding portion 66 may be snapped onto the board-end guiding portion 621 as well as the screw element 47 is threadedly engaged with and then fix the through hole 455 and the board-end locating hole 625. Thereby, the plug-in stability and reliability of the SATA data connection device 60 may be raised.

The foregoing description is merely one embodiment of the present invention and not considered as restrictive. All equivalent variations and modifications in shape, structure, feature, and spirit in accordance with the appended claims may be made without in any way from the scope of the invention.

1. A SATA data connection device with raised reliability, mainly comprising:
a SATA data connection seat, provided with a seat body having two long perimeters and two short perimeters formed around the outer surface thereof, inside said seat body, there being provided with a slot, while on at least one of said short perimeters of said seat body, there being provided with a support frame having a snap-fit groove, on one side of which a snap-fit wall is provided; and
a SATA component terminal, provided with a shell layer having two long perimeters and two short perimeters formed around the outer surface thereof, at the bottom end of said SATA component terminal, there being provided with a SATA data connector, while on at least one of said short perimeters of said shell layer, there being connectedly provided with a snap fitting comprising a snap hook extending downwardly and movable, said SATA data connector capable of being insertedly connected to said slot, while said snap fitting leading said snap hook to pass through said snap-fit groove and then snap onto said snap-fit wall fixedly via the application of an external force.

2. The SATA data connection device according to claim 1, wherein:
said snap fitting is connected at the front end thereof to the bottom end of said short perimeter of said shell layer, and is provided in the middle thereof with a press portion; and
said snap-fit groove is provided at the lower edge of one side thereof with a snap-fit opening, while said snap-fit opening is formed at the top end thereof as said snap-fit wall, said snap-fit opening being in the form of an geometric-shaped opening, a hollowed out body or a physical thin wall.

3. The SATA data connection device according to claim 1, wherein said snap fitting comprises said snap hook, a press portion, a position limit groove and a elastic element, said press portion being connected to the top end of said snap hook, said position limit groove being provided at the lower edge of said SATA component terminal, said elastic element being located within said position limit groove, said press portion being allowed to move within said position limit groove when it is affected by said elastic element.

4. The SATA data connection device according to claim 1, wherein said SATA data connection seat is provided with at least one extension frame having a locating hole, while said SATA component terminal is provided with at least one through hole, a screw element being used to fix said locating hole and said through hole, said extension frame being fixed on said seat body or said support frame.

5. The SATA data connection device according to claim 1, wherein said data connection seat lies horizontally against a printed circuit board, said seat body being provided on at least one of said short side perimeters thereof with a guide frame, said guide frame being provided at the inner side thereof with a board-end guiding portion, while said short perimeter of said SATA component terminal being provided with a component-end guiding portion, said board-end guiding portion and said component-end guiding portion being allowed to embeddedly connect with each other.

6. The SATA data connection device according to claim 5, wherein said seat body is provided on at least one of said short perimeters thereof with said support frame to which said guide frame is fixedly connected, and wherein said printed circuit board is drilledly provided with at least one board-end locating hole as well as said SATA component terminal is provided with a through hole, a screw element being used to fix said board-end locating hole and said through hole.

7. The SATA data connection device according to claim 1, wherein said SATA component terminal is an electronic application module with SATA interface or a SATA data transmission line, while a memory module, an application program module, or a communication module is provided in said electronic application module with SATA interface.

8. A SATA data connection device with raised reliability, mainly comprising:
a SATA data connection seat, provided with a seat body having a slot therein, said seat body being projectingly provided on at least one side thereof with an upward extension frame in which a locating hole is provided;
a SATA component terminal provided at the bottom end thereof with a SATA data connector, and at the lower edge thereof with at least one through hole; and
a screw element allowed to pass through as well as fix said locating hole and said through hole.

9. The SATA data connection device according to claim 8, wherein said locating hole is provided with a locating hole thread, while said through hole is provided with a through hole thread, and wherein a screw element is allowed to pass through and fix a plurality of said through holes simultaneously.

10. The SATA data connection device according to claim 8, wherein two long perimeters and two short perimeters are formed around the outer surface of said seat body, said seat body being provided on at least one of said short perimeters thereof with a support frame to which said extension frame is fixedly connected.

11. The SATA data connection device according to claim 8, wherein said SATA component terminal is an electronic application module with SATA interface or a SATA data transmission line, while a memory module, an application program module, or a communication module is provided in said electronic application module with SATA interface.

12. A SATA data connection device with raised reliability, mainly comprising:
a SATA data connection seat, lying horizontally against a printed circuit board, provided with a seat body having two long perimeters and two short perimeters formed around the outer surface thereof, there being provided inside said seat body with a slot, while there being provided on at least one of said short perimeters of said seat body with a guide frame, said guide frame being provided at the inner side thereof with a board-end guiding portion; and
a SATA component terminal, having two long perimeters and two short perimeters formed around the outer surface thereof, being provided at the bottom end thereof with a SATA data connector, while on at least one of said short perimeters with a component-end guiding portion, said SATA data connector being allowed to insertedly connect to said slot, while said component-end guiding portion and said board-end guiding portion being allowed to embeddedly connect with each other.

13. The SATA data connection device according to claim 12, wherein said seat body is provided on at least one of said short perimeters thereof with a support frame to which said guide frame is fixedly connected, and wherein said printed circuit board is provided with a board-end locating hole as well as said SATA component terminal is provided with a through hole, a screw element being used to pass through as well as fix said board-end locating hole and said through hole.

14. The SATA data connection device according to claim 12, wherein said SATA component terminal is an electronic application module with SATA interface or a SATA data transmission line, while a memory module, an application program module, or a communication module is provided in said electronic application module with SATA interface.

15. A SATA data connection device with raised reliability, which is a SATA component terminal provided at the bottom end thereof with a SATA data connector, and at the lower edge thereof with at least one through hole through which a screw element may pass or with which a screw may screwly engage, said SATA component terminal being an electronic application module with SATA interface or a SATA data transmission line.

16. The SATA data connection device according to claim 15, wherein said through hole is provided therein with a through hole thread.

17. The SATA data connection device according to claim 15, wherein said SATA component terminal is provided on at least one of said short perimeters thereof with a component-end guiding portion, and on at least one of said long perimeters thereof with a compression-fit means.

18. A SATA data connection device with raised reliability, which is a SATA component terminal comprising a shell layer having two long perimeters and two short perimeters formed around the outer surface thereof, said shell layer being projectingly provided at the bottom end thereof with a SATA data connector, and at the lower edge of at least one of said short perimeters thereof with a snap fitting connected at the front end thereof to the bottom end of said short perimeter of said shell layer as well as formed at the rear end thereof as a movable snap hook, said SATA component terminal being an electronic application module with SATA interface or a SATA data transmission line.

19. The SATA data connection device according to claim 18, wherein said snap fitting comprises a press portion, a position limit groove and a elastic element, said press portion being connected to the top end of said snap hook, said position limit groove being provided at the lower edge of said SATA component terminal, said position limit groove being provided with said elastic element therein, said press portion being allowed to move within said position limit groove when it is affected by said elastic element.

20. The SATA data connection device according to claim 18, wherein said SATA component terminal is provided on at least one of said short perimeters thereof with a component-end guiding portion, and on at least one of said long perimeters thereof with a compression-fit means.

21. A SATA data connection device with raised reliability, which is a SATA component terminal provided at the bottom end thereof with a SATA data connector as well as having two long perimeters and two short perimeters formed around the outer surface thereof, said SATA component terminal being provided on at least one of said short perimeters thereof with a component-end guiding portion which is operated as a guide rail groove or a projecting guide strip, said SATA component terminal being an electronic application module with SATA interface or a SATA data transmission line.

22. A SATA data connection device with raised reliability, which is a SATA data connection seat, provided with a seat body having two long perimeters and two short perimeters formed around the outer surface thereof, said seat body being provided therein with a slot and provided with at least one support frame laterally extending on at least one of said short perimeters of said seat body, or at least one extension frame projecting upwardly from the outer surface of said seat body, or at least one guide frame located on at least one of said short perimeters of said seat body, wherein said support frame is provided with a snap-fit groove having a snap-fit wall at one side thereof, said extension frame is provided with a locating hole, and said guide frame is provided at inner side thereof with a board-end guiding portion.

23. The SATA data connection device according to claim 22 wherein said snap-fit groove is provided at the lower edge of one side thereof with a snap-fit opening, while said snap-fit opening is formed at the top end thereof as said snap-fit wall, said snap-fit opening being in the form of an geometric-shaped opening, a hollowed out body or a physical thin wall.
